(19) United States
(12) Patent Application Publication
(10) Pub. No.: US 2006/0092667 A1
(43) Pub. Date: May 4, 2006

(54) Backlight module with built-in light source

(75) Inventor: Xiao-Shuai Peng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/263,432

(22) Filed: Oct. 31, 2005

(30) Foreign Application Priority Data
Oct. 29, 2004 (TW) 93132938

(51) Int. Cl. F21V 7/04

(52) U.S. Cl. 362/615; 362/614

(57) ABSTRACT

A backlight module (30) includes a light guide plate (32) and a light source. The light guide plate includes a light output surface (328), a bottom surface (327), and a plurality of side surfaces (324, 325, 326, 329). A channel (33) having a first exit (331) and a second exit (333) is formed within the light guide plate, with the first and the second exits being located at two of the side surfaces respectively. The light source is disposed in the channel for introducing light into the light guide plate. Light beams emitting by the light source are emitted from the light output surface. Therefore, the backlight module has highly efficient utilization of light beams.

### FIELD OF THE INVENTION

The present invention relates to backlight modules for use in liquid crystal displays or the like, and especially to a backlight module with highly efficient utilization of light beams.

### BACKGROUND

Most portable electronic devices such as laptop and notebook computers, mobile phones and game devices have viewing screens unlike the cathode-ray-tube (CRT) monitors of conventional desktop computers. Users generally expect the viewing screens to provide performance equal to that of CRT monitors. To meet this demand, computer manufacturers have sought to build flat panel displays (FPDs) offering superior resolution, color and contrast, while at the same time requiring minimal power consumption. LCDs are one type of FPD which satisfy these expectations. However, the liquid crystals of an LCD are not self-luminescent. Rather, the LCD generally needs a surface emitting device such as backlight module which offers sufficient luminance (brightness) in a wide variety of ambient light environments.

A light guide plate is a key component of a backlight module used in an LCD. Typically, the light guide plate is either of two shapes: a sheet having a uniform thickness (“planar”), or a wedge-shaped sheet (“wedgy”). Both these kinds of light guide plates convert a point light source or a linear light source into a surface light source.

As shown in FIG. 4, a typical backlight module 10 includes a planar light guide plate 1, a reflector 2, a diffuser 3, a first prism 4, a second prism 5, a light source 6, and a U-shaped shield 7. The light guide plate 1 includes a light output surface 12, a bottom surface 11 opposite to the light output surface 12, and a light incident surface 13 interconnecting the light output surface 12 and the bottom surface 11. The reflector 2 is disposed adjacent to the bottom surface 11. The diffuser 3, the first prism 4, and the second prism 5 are disposed upon the light output surface 12 in that order. The U-shaped shield 7 is disposed adjacent to the light incident surface 13 and partly covers the light source 6, thereby facilitating transmission of light beams emitted by the light source 6 to the light guide plate 1.

In operation, light beams emitted from the light source 6 enter the light guide plate 1. Some of the light beams are reflected and then exit through the output surface 12, and other light beams directly exit through the output surface 12. All of the light beams that exit through the output surface 12 then transmit through the diffuser 3, the first prism 4 and the second prism 5, and finally illuminate a liquid crystal panel (not shown).

However, when the U-shaped shield 7 is attached to the light guide plate 1, a gap may be created therebetween. When this happens, some of the light beams emitted from the light source 6 are liable to leak out through the gap and be lost. In addition, other light beams emitted from the light source 6 may be absorbed by the U-shaped shield 7. Thereby, the backlight module 10 may have low efficiency in utilization of light beams.

What is needed, therefore, is a backlight module which can provide highly efficient utilization of light beams.

### SUMMARY

A backlight module includes a light guide plate and a light source. The light guide plate includes a light output surface, a bottom surface, and a plurality of side surfaces. A channel having a first exit and a second exit is formed within the light guide plate, with the first and the second exits being located at two of the side surfaces respectively. The light source is disposed in the channel for introducing light into the light guide plate.

The light source includes a first electrode, a second electrode, and a combination of phosphor, mercury, and one or more inert gases. The first and the second electrodes are respectively disposed at the first and the second exits for applying a voltage to the combination.

In operation, because the light source is located within the light guide plate, all of light beams emitted by the light source are subsequently emitted out from the light output surface of the light guide plate. Therefore, the backlight module has highly efficient utilization of light beams. Further, the backlight module eliminates the need for a light source shield, thereby reducing the cost of the backlight module.

Other advantages and novel features will become more apparent from the following detailed description when taken in conjunction with the accompanying drawings.

### BRIEF DESCRIPTION OF THE DRAWINGS

FIG. 1 is an exploded, isometric view of a backlight module according to a first embodiment of the present invention.

FIG. 2 is an exploded, isometric view of a backlight module according to a second embodiment of the present invention.

FIG. 3 is an exploded, isometric view of a backlight module according to a third embodiment of the present invention.

FIG. 4 is a schematic, exploded, side view of a typical backlight module.

### DETAILED DESCRIPTION OF PREFERRED EMBODIMENTS

Referring to FIG. 1, an exploded, isometric view of a backlight module according to a first embodiment of the present invention is shown. The backlight module 30 includes a light guide plate 32 and a bottom reflector 36. The light guide plate 32 includes a light output surface 328, a bottom surface 327 opposite to the light output surface 328, and a plurality of side surfaces 324, 325, 326, 329 interconnecting the light output surface 328 and the bottom surface 327. The bottom reflector 36 is disposed adjacent to the bottom surface 327.

A channel 33 having a first exit 331 and a second exit 333 is defined within the light guide plate 32. The first and second exits 331, 333 are disposed at the opposite side surfaces 325, 329 respectively.

A combination of phosphor 332, mercury 334, and one or more inert gases 336 is filled in the channel 33. The inert gases 336 may be neon gas, argon gas and/or helium gas. A first and a second electrodes 338, 339 are respectively disposed at the first and second exits 331, 333, for applying a voltage to the combination. The combination and the first and second electrodes 338, 339 cooperatively define a linear light source (not labeled), for introducing light beams into the light guide plate 32.

The light guide plate 32 is wedgy, and the first and the second exits 331, 333 are disposed close to the thickest side surface 326. Preferably, a plurality of side reflectors (not shown) are disposed on the side surfaces 324, 325, 326, 329, so as to prevent light beams from leaking out from the side surfaces 324, 325, 326, 329.

In operation, because the light source is disposed within the light guide plate 32, all of the light beams emitted by the light source are emitted out from the light output surface 328 of the light guide plate 32. Therefore, the backlight module 30 has highly efficient utilization of light beams. In addition, the backlight module 30 eliminates the need for a light source shield, thereby reducing the cost of the backlight module 30.

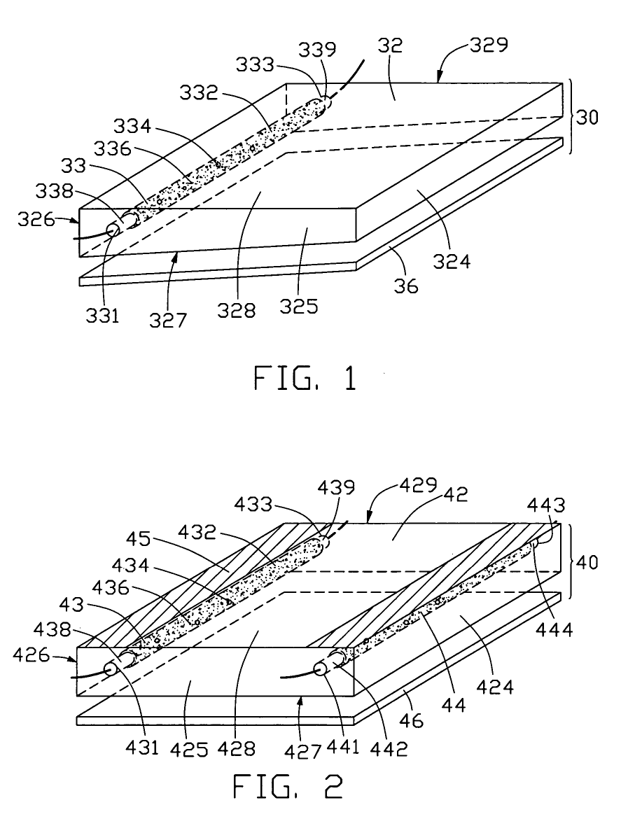

Referring to FIG. 2, an exploded, isometric view of a backlight module according to a second embodiment of the present invention is shown. The backlight module 40 includes a planar light guide plate 42 and a bottom reflector 46. The light guide plate 42 includes a light output surface 428, a bottom surface 427, and a plurality of side surfaces 424, 425, 426, 429. The bottom reflector 46 is disposed adjacent to the bottom surface 427.

A first channel 43 having a first exit 431 and a second exit 433 is defined within the light guide plate 42. The first and second exits 431, 433 are disposed at the two opposite side surfaces 425, 429 respectively. A second channel 44 having a third exit 441 and a fourth exit 443 is defined within the light guide plate 42. The third and fourth exits 441, 443 are disposed at the two opposite side surfaces 425, 429 respectively. The first and second exits 431, 433 are disposed close to the side surface 426, and the third and fourth exits 441, 443 are disposed close to the side surface 424.

A combination of phosphor 432, mercury 434, and one or more inert gases 436 is filled in the first channel 43. The inert gases 436 may be neon gas, argon gas and/or helium gas. A first and a second electrodes 438, 439 are respectively disposed at the first and second exits 431, 433, for applying a voltage to the combination. The combination and the first and second electrodes 438, 439 cooperatively define a first linear light source (not labeled). A combination the same as that described above is filled in the second channel 44. A third and a fourth electrodes 442, 444 are respectively disposed at the third and fourth exits 441, 443, for applying a voltage to the combination. The combination and the third and fourth electrodes 442, 444 cooperatively define a second linear light source (not labeled). The first and second linear light sources introduce light into the light guide plate 42.

The light output surface 428 defines two high irradiance regions (not labeled), corresponding to the first and the second channels 43, 44 respectively. Two reflectors 45 are disposed at the high irradiance regions respectively.

In operation, because the light sources are disposed within the light guide plate 42, all light beams emitted by the light sources are emitted from the light output surface 428 of the light guide plate 42. Therefore, the backlight module 40 has highly efficient utilization of light beams. In addition, the backlight module 40 eliminates the need for a light source shield, thereby reducing the cost of the backlight module 40.

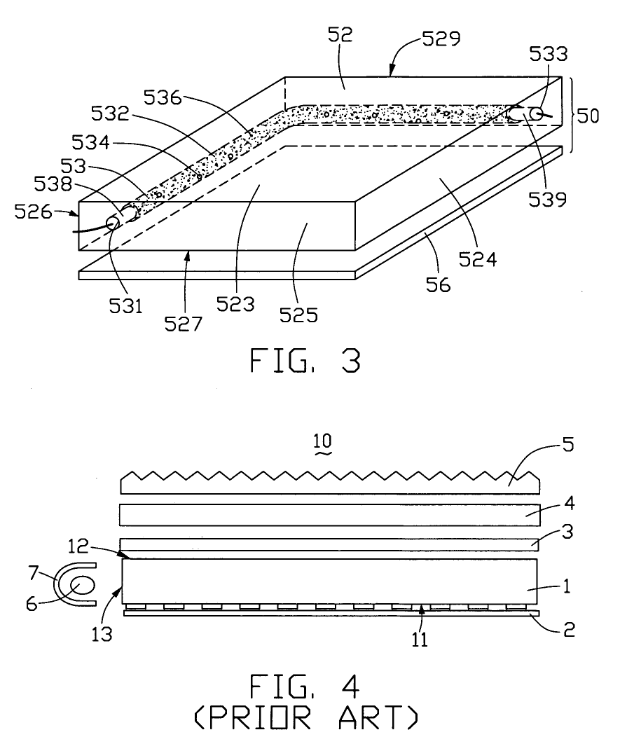

Referring to FIG. 3, an exploded, isometric view of a backlight module according to a third embodiment of the present invention is shown. The backlight module 50 includes a light guide plate 52 and a bottom reflector 56. The light guide plate 52 includes a light output surface 528, a bottom surface 527, and a plurality of side surfaces 524, 525, 526, 529. The bottom reflector 56 is disposed adjacent to the bottom surface 527.

A channel 53 having a first exit 531 and a second exit 533 is defined within the light guide plate 52. The first and second exits 531, 533 are disposed at the two adjacent side surfaces 525, 524 respectively.

A combination of phosphor 532, mercury 534, and one or more inert oases 536 is filled in the channel 53. The inert gases 536 may be neon gas, argon gas and/or helium gas. A first and a second electrodes 538, 539 are respectively disposed at the first and the second exits 531, 533, for applying a voltage to the combination. The combination and the first and second electrodes 538, 539 cooperatively define an L-shaped light source (not labeled).

In operation, because the light source is disposed within the light guide plate, all light beams emitted by the light source are emitted from the light output surface 528 of the light guide plate 52. Therefore, the backlight module 50 has highly efficient utilization of light beams. In addition, the backlight module 50 eliminates the need for a light source shield, thereby reducing the cost of the backlight module 50.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
a light guide plate comprising a light output surface, a bottom surface opposite to the light output surface, and a plurality of side surfaces between the light output surface and the bottom surface, the light guide plate defining a channel therein, the channel having a first exit and a second exit, the first and the second exits being located at two of the side surfaces respectively; and
a light source disposed in the channel for introducing light into the light guide plate.

2. The backlight module as claimed in claim 1, wherein the light source comprises a combination of phosphor, mercury, and one or more inert gases.

3. The backlight module as claimed in claim 2, wherein the light source further comprises a first electrode and a second electrode respectively disposed at the first and the second exits for applying a voltage to the combination.

4. The backlight module as claimed in claim 3, wherein the first and the second exits are respectively disposed at two opposite of the side surfaces.

5. The backlight module as claimed in claim 4, wherein the light source is linear.

6. The backlight module as claimed in claim 5, wherein the light output surface defines a high irradiance region corresponding to the channel.

7. The backlight module as claimed in claim 6, further comprising a reflector disposed at the high irradiance region.

8. The backlight module as claimed in claim 3, wherein the first and the second exits are respectively disposed at two adjacent of the side surfaces.

9. The backlight module as claimed in claim 8, wherein the light source is L-shaped.

10. The backlight module as claimed in claim 3, wherein a profile of the light guide plate has a uniform thickness or is wedgy.

11. The backlight module as claimed in claim 3, further comprising a bottom reflector disposed under the bottom surface.

12. A backlight module comprising:
a light guide plate comprising a light emitting surface and a plurality of side surfaces;
a light source essentially embedded within the light guide plate.

13. The backlight module as claimed in claim 12, wherein said light source extending along a direction parallel to said light emitting surface.

14. The backlight module as claimed in claim 12, wherein said light guide plate defines therein an internal channel in which the light source is received.

15. The backlight module as claimed in claim 14, wherein said channel extends parallel to the light emitting surface.

16. The backlight module as claimed in claim 15, wherein said channel is surrounded by said light guide plate except at least one axis end thereof.

17. A method of making a backlight module, comprising the steps of:
providing a light guide plate with a light emitting surface and at least one side surface;
forming a cavity in said light guide plate; and
disposing a light source into the cavity.

18. The method as claimed in claim 17, wherein said light source is essentially fully embedded within the light guide plate.

19. The method as claimed in claim 17, wherein said cavity is of a channel configuration and said light source is tubular.

20. The method as claimed in claim 19, wherein said light source is assembled into the cavity along an axis of said channel configuration.
